(19) United States
(12) Patent Application Publication
(10) Pub. No.: US 2007/0030777 A1
(43) Pub. Date: Feb. 8, 2007

(54) Digital data reproducing device

(76) Inventors: Hideyuki Yamakawa, Kawasaki-shi (JP); Koichi Otake, Yokohama-shi (JP); Yukiyasu Tatsuzawa, Yokohama-shi (JP); Hiroyuki Moro, Fussa-shi (JP); Toshihiko Kaneshige, Yokohama-shi (JP); Hiroaki Morino, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/498,072

(22) Filed: Aug. 3, 2006

(30) Foreign Application Priority Data
Aug. 4, 2005 (JP) 2005-226745

(51) Int. Cl. G11B 20/10

(52) U.S. Cl. 369/47.28

(57) ABSTRACT

An optical disk device which decodes data recorded on an optical disk, comprises a first measuring unit which measure a cycle of a plurality of first synchronous signal regions VFO contained in a reproduction signal from an optical pickup, a cycle comparing unit which compares the measurement result of the first measuring unit with a first predetermined cycle, a second measuring unit which measures a cycle of a plurality of second synchronous signal regions SYNC which are contained in the reproduction signal from the optical pickup and have the cycle shorter than that of the plurality of first synchronous signal regions VFO, a cycle comparing unit which compares the measurement result of the second measuring unit with a second predetermined cycle, and an oscillator which generates a clock signal CKS for sampling the reproduction signal on the basis of the comparison results of the first and second cycle comparing units.

### CROSS-REFERENCE TO RELATED APPLICATIONS

This application is based upon and claims the benefit of priority from Japanese Patent Application No. 2005-226745, filed Aug. 4, 2005, the entire contents of which are incorporated herein by reference.

### BACKGROUND

1. Field

The present invention relates to an optical disk device which decodes information recorded on an optical disk, and more particularly, to a circuit which generates a sampled clock to be used for decoding a reproduction signal.

2. Description of the Related Art

In the case where information recorded on, for example, an optical disk is reproduced by an optical disk device, such as a disk drive or DVD recorder, which is incorporated in a personal computer (PC) or the like, a recording surface of the optical disk is irradiated with laser beam from an optical pickup which moves in a radial direction of the optical disk. The laser beam reflected by the recording surface is received by, for example, a four-divided light receiving element provided in the optical pickup, and a light detection signal is generated from each light-receiving cell. Based on the light detection signal, laser beam focusing and tracking, and information reproduction are carried out.

A signal obtained by adding all optical detection signals generated from a plurality of light-receiving cells is provided as a reproduction signal. Conventionally, the reproduction signal has been digitized by simple binarization using a comparator or the like. However, in recent years, a reproduction signal is digitized by the use of a partial response maximum likelihood (PRML) technique in order to reproduce information recorded at high density.

To digitize a reproduction signal using the PRML technique, it is necessary to generate a sampled clock that is phase-synchronized with a reproduction signal of an optical disk. The sampled clock is a clock signal which has a frequency of a reference clock signal used when information is recorded on an optical disk. In synchronism with the sampled clock, the reproduction signal is decoded.

Jpn. Pat. Appln. KOKAI Publication No. 2001-195830 (paragraph 0064, FIG. 9) discloses a technique to detect an error between a frequency of a reproduction signal and a frequency of a sampled clock generated by a reproduction circuit when such a sampled clock is generated.

In the above publication, a zero-cross length of the reproduction signal is measured in order to detect the error between the frequency of the reproduction signal and the frequency of the sampled clock generated by the reproduction circuit. However, in the case where this technique is applied to high-density recording media such as HD DVD, it is difficult to correctly measure the zero-cross length due to strong intersymbol interference, and it is unable to carry out high-accuracy frequency control.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing a configuration of a data reproduction circuit for an optical disk according to the present invention;

FIGS. 2A to 2C show a relationship between a VFO detected pulse and a SYNC detection pulse with respect to a data format of a reproduction signal;

FIG. 3 is a diagram showing a configuration of a frequency error detection unit 1 according to the present invention;

FIG. 4 is a diagram showing a configuration of a frequency error detection unit 2 according to the present invention;

FIG. 5 is a diagram showing a configuration of a synchronous pattern detector according to the present invention; and

FIG. 6 is a diagram showing a configuration of a data reproduction circuit for an optical disk according to the present invention.

### DETAILED DESCRIPTION

Various embodiments according to the invention will be described hereinafter with reference to the accompanying drawings. In general, according to one embodiment of the invention, in order to achieve the above object, according to one aspect of the present invention, there is provided an optical disk device which decodes data recorded on an optical disk, comprising: an optical pickup which provides a reproduction signal by irradiating an optical disk with laser beam and detecting reflected light from the optical disk; an analog-digital converter which digitizes the reproduction signal provided from the optical pickup; a transversal filter which waveform-equalizes the reproduction signal provided from the analog-digital converter; a first measuring unit which measures a cycle of a plurality of first synchronous signal regions contained in an output signal of the transversal filter; a first comparing unit which compares the measurement result of the first measuring unit with a first predetermined cycle; a second measuring unit which measures a cycle of a plurality of second synchronous signal regions which are contained in an output signal of the transversal filter and have the cycle shorter than the cycle of said plurality of first synchronous signal regions; a second comparing unit which compares the measurement result of the second measuring unit with a second predetermined cycle; and a generating unit which generates a clock signal for sampling the reproduction signal and provides the clock signal to the analog-digital converter on the basis of the comparison results of the first and second comparing units.

According to one embodiment of the present invention, it is possible to suppress effects of intersymbol interference and to carry out high-accuracy frequency control when a high-density optical disk represented by HD DVD is reproduced.

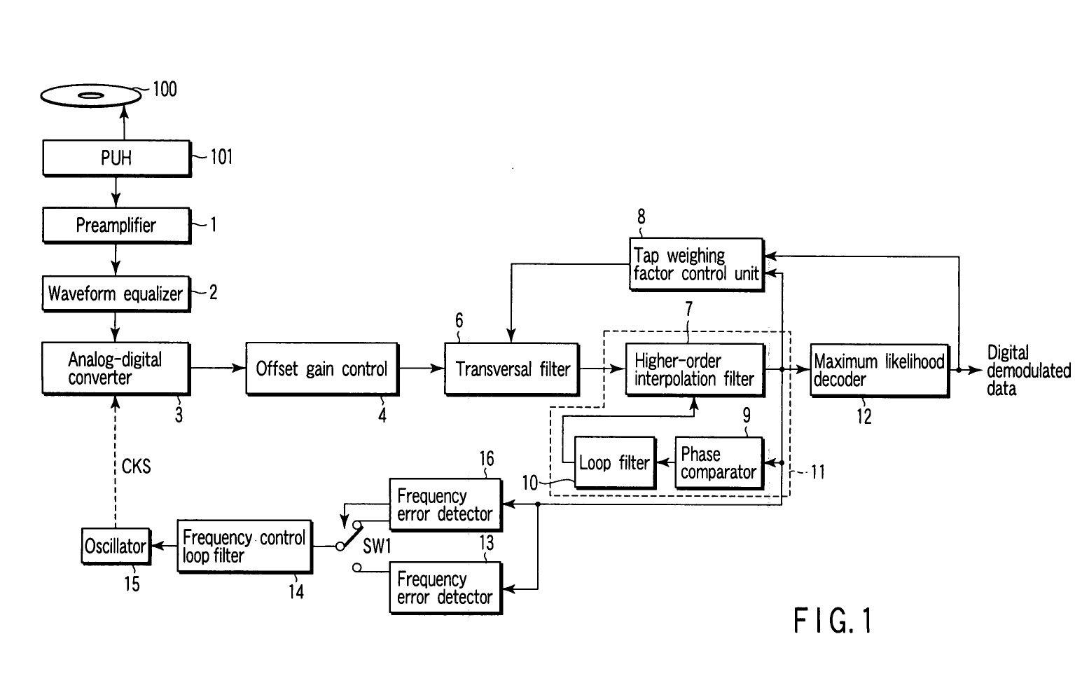

FIG. 1 is a diagram showing a configuration of an optical disk device and a signal reproduction circuit to which the present invention is applied.

Reference numeral 100 denotes an optical disk medium. An optical pickup head (PUH) 101 outputs a reproduction signal by irradiating the optical disk medium with appropriate laser beam and detecting reflected light from the optical disk medium.

The reproduction signal output from the PUH 101 is amplified by a preamplifier 1, and is corrected in such a manner as to enhance the high frequency region by a waveform equalizer 2. The waveform equalizer 2 comprises, for example, a filter such as a high-order or other ripple filter, which can optionally set the boost rate and cut-off frequency. An analog output signal of the waveform equalizer 2 is sampled into a multi-bit digital signal (for example, 8-bit) by an analog-digital converter 3. The clock used for the analog-digital converter 3 is a clock CKS generated by an oscillator 15, and is a clock asynchronous with a clock component of the reproduction signal. The clock CKS or a signal that frequency-divides the clock CKS is supplied to each circuit block of a signal processing circuit shown in FIG. 1 as a clock signal.

The multi-bit digital signal sampled by the analog-digital converter 3 is input to an offset gain control unit 4. The offset gain control unit 4 corrects an offset component contained in the reproduction digital signal and at the same time adjusts the reproduction digital signal such that amplitude of the reproduction digital signal coincides with a desired value. Then, an output signal of the offset gain control unit 4 is input to a transversal filter 6. The transversal filter 6 carries out partial response equalization such that the signal becomes a predetermined partial response class signal. It is assumed that partial response equalization is carried out by the use of, for example, PR (12221) system. A signal subjected to partial-response equalization by the transversal filter 6 is converted into a signal value in a normal sampling phase by a high-order interpolation filter 7. An interpolation phase position at this time is controlled by an output of a loop filter 10.

An output signal of the high-order interpolation filter 7 is inputted to a tap weighing factor control unit 8. The tap weighing factor controller unit 8 adaptively controls a tap weighing factor of the transversal filter 6 by using an equalization error obtained from a maximum likelihood decoder 12 such that the equalization error is reduced to minimum. The tap weighing factor control unit 8 may use, for example, a least mean square algorithm. A phase comparator 9 detects a phase error between the output signal of the high-order interpolation filter 7 and an ideal signal waveform generated by the phase comparator 9. The loop filter 10 smoothes a phase error signal output from the phase comparator 9, and the output signal controls a filter factor of the high-order interpolation filter 7 as phase control information. The phase comparator 9, loop filter 10, and high-order interpolation filter 7 constitute a digital phase synchronous loop 11.

Using the partial-response equalized waveform at a normal phase, output by the series of operations described above, the maximum likelihood decoder 12 decodes data in accordance with the type of partial response. In this case, the maximum likelihood decoder 12 is, for example, a Viterbi decoder.

A frequency error is detected from the output signal of the high-order interpolation filter 7 by using either the frequency error detector 13 or the frequency error detector 16. The frequency control loop filter 14 smoothes a frequency error signal output from the frequency error detector 13 or 16, and outputs an oscillation control signal to the oscillator 15. The oscillator 15 supplies a sampled clock CKS having a frequency corresponding to the oscillation control signal to the analog-digital converter 3. Means for controlling the sampled clock CKS of the analog-digital converter 3 is achieved by a frequency control loop constituted by the frequency error detectors 13, 16, the frequency control loop filter 14, and the oscillator 15.

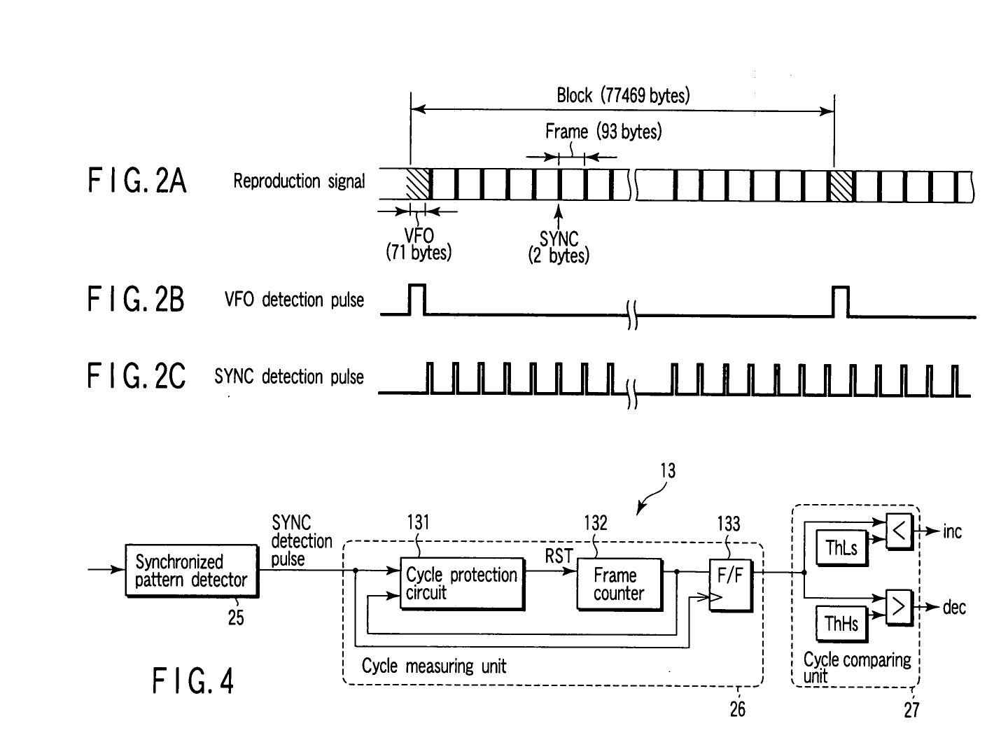

Now, description will be made on a recording data format of an applicable optical disk medium. Various forms are conceivable for this recording data format, but in the present embodiment, description will be made with reference to a recording data format disclosed in Jpn. Pat. Appln. KOKAI Publication No. 2004-303344 as an example. Needless to say, the present invention is not be limited to the recording format but can be applied to recording media of other recording formats. In the case of an optical disk disclosed in Jpn. Pat. Appln. KOKAI Publication No. 2004-303344, recording data is recorded with 77469-byte (929628 channel bits) data, which is called a block, used as a unit as shown in FIG. 2A. In the head of this block, data of a single cycle called a VFO region of 71 bytes (852 channel bits) is recorded. In a data region following the VFO region, 832 frames are recorded with 93-byte (1116 channel bits) data called a frame as a unit. In the head two bytes (24 channel bits) of individual frames, special data, which is called a SYNC pattern, for identifying the frame head is recorded.

(Frequency Error Detector 16)

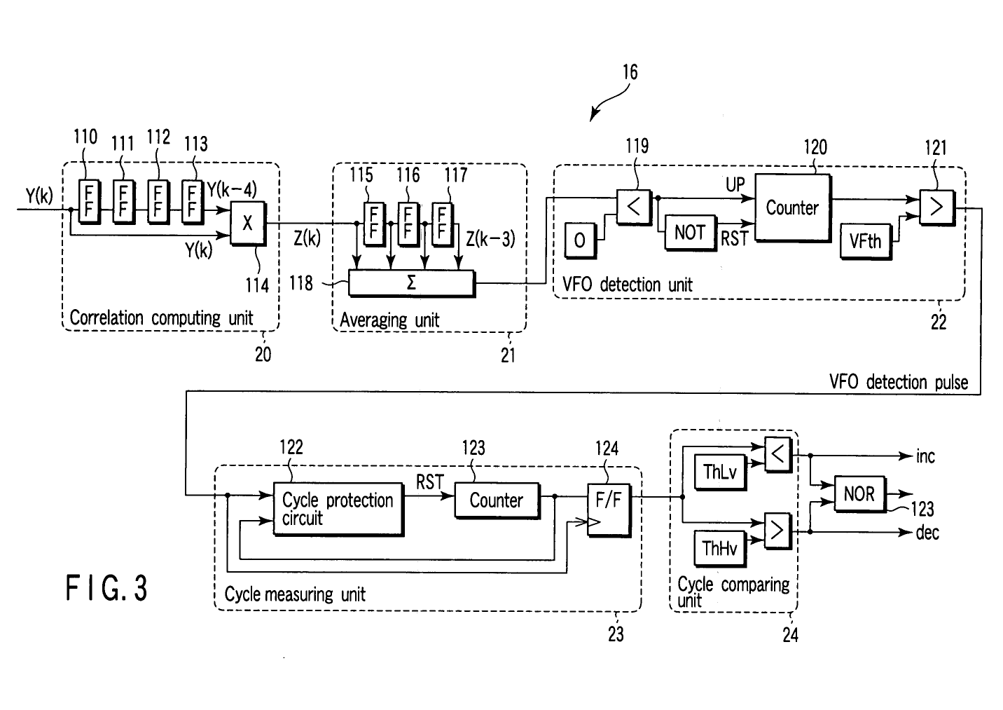

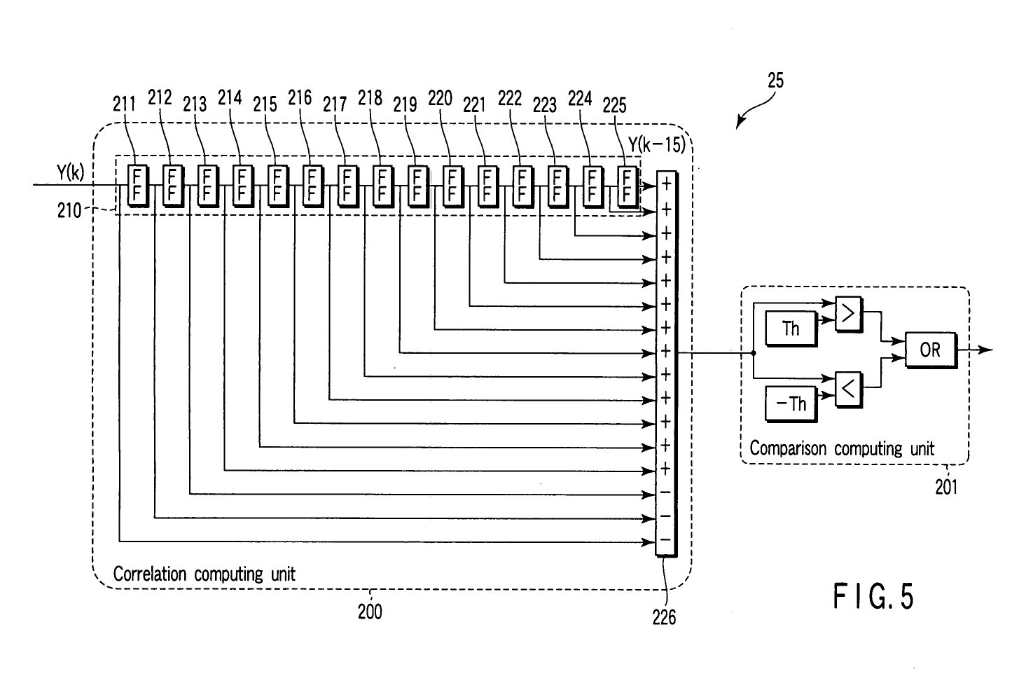

Now, detailed description will be made on the frequency error detector 16 with reference to FIG. 3. The frequency error detector 16 comprises a correlation computing unit 20, an averaging unit 21, a VFO detection unit 22, a cycle measuring unit 23, and a cycle comparing unit 24. The correlation computing unit 20 comprises flipflops 110 to 113 and a multiplier 114. The bit number of each flipflop is same as the bit number of the output signal of the high-order interpolation filter 7, and the clock CKS generated by the oscillator 15 is used for clock.

Here, by computing the self-correlation of an input signal, a constant cycle pattern specific to the VFO region is detected. Specifically, an input signal of the correlation computing unit 20 at time k is defined as Y(k), and this signal is delayed by 1 clock each by the flipflops 110 to 113. Then, an output of the flipflop 113 becomes a signal Y(k−4) delayed by 4 clocks with respect to the input signal Y(k). In the multiplier 114, operation of Y(k)*Y(k−4) is carried out. As described above, a constant-cycle signal whose cycle is 8-channel clock is recorded in the VFO region. Therefore, in the VFO region, self-correlation between signals which are 4-clock apart from each other forms a relation of a reverse phase, and a negative correlation is maximized. Even if the oscillation frequency of the oscillator 15 is slightly deviated from a channel clock frequency of a reproduction signal, self-correlation between signals which are 4-clock apart from each other indicates a strong negative correlation in the VFO region. However, since various noise components are included in an actual reproduction signal, an averaging process for removing such noise components is carried out at the averaging unit 21. In the example of FIG. 3, assuming that the output of the correlation computing unit 20 is Z(k), the total sum of Z(k) of four consecutive samples, that is, Z(k)+Z(k−1)+Z(k−2)+Z(k−3) is computed. It suffices that the number of samples in the summation interval (4 samples in the present example) is set to an appropriate value by a signal-to-noise ratio of the actual reproduction signal, and 6 samples or 8 samples may be suited.

Based on the output value of the averaging unit 2, the VFO detection unit 22 evaluates the intensity of negative correlation. A comparator 119 determines whether or not a signal entered from the averaging unit 21 is negative. In the case of negative, the comparator 119 outputs “1.” A counter 120 is a counter which counts up one by one when the input signal is “1” and which has its output value reset to zero when the input signal is “0.” That is, when the output value of the averaging unit 21 is negative, the counter 120 counts up on the basis of the clock CKS, and when the output value of the averaging unit 21 is positive, the counter 120 is reset to zero. The output signal of the counter 120 is compared with a threshold value (VFth) predetermined by the comparator 121, and when the value of the counter 120 is greater than the threshold value (VFth), the VFO region detection output becomes “1” (VFO detection pulse). FIG. 2B is a timing chart which indicates how the VFO detection pulse is generated. With such a configuration, it is detected whether or not the reproduction signal from the optical disk medium is the signal in the VFO region.

Next, the cycle measuring unit 23 will be described in detail. As described above, in the optical disk medium according to the invention, data of a single cycle called a VFO region is recorded every 77469 bytes (929628 channel bits). Consequently, it is possible to find an error between the reproduction signal from a disk and the oscillation frequency of the oscillator 15 by measuring the cycle of the VFO region starting point. However, since detection of the VFO region may include erroneous detection and nondetection, measures must be taken. A cycle protection circuit 122 has a function of making a detection signal effective only in a time zone where the VFO region can be detected for the next time based on the previous VFO region detection cycle. The VFO detection pulse determined to be effective by the cycle protection circuit 122 is inputted to a counter 123. In this case, the counter 123 is reset to zero, and unless the VFO region is detected, the counter 123 begins to count up in response to the clock CKS of the oscillator 15. The cycle protection circuit 122 predicts the arrival of the next VRO detection pulse based on the value output by the counter 123. When the next VFO detection pulse is input, the value of the last counter 123 is held by a flipflop 124 and becomes cycle information of the last VFO region. In the case where the oscillation frequency of the oscillator 15 is equal to the frequency of the reproduction signal, the value held by the flipflop 124 is 929628, which is the cycle of the VFO region.

In the case where the value of the flipflop 124 is smaller than a predetermined value (ThHv), the cycle comparing unit 24 outputs a signal (inc: “1”) which increases the oscillation frequency of the oscillator 15. On the other hand, in the case where the value of the flipflop 124 is greater than the predetermined value (ThHv), the cycle comparing unit 24 outputs a signal (dec: “1”) which decreases the oscillation frequency of the oscillator 15. The inc signal and the dec signal are supplied to the frequency control loop filter 14. In this way, by measuring the VFO region cycle by the use of the clock CSK, it is possible to detect an oscillation frequency error of the oscillator 15.

(Frequency Error Detector 13)

When the frequency control of the oscillator 15 is controlled by using the above-mentioned frequency error detector 16 and the oscillation frequency approaches to the frequency of the reproduction signal, that is, both the inc signal and dec signal of the cycle comparing unit 24 are “zero” (when the output of NOR123 is “1”), a switch SW1 is changed over and frequency error detection is carried out by the frequency error detector 13. A difference between the frequency error detector 16 and the frequency error detector 13 lies in the point that the frequency error detector 16 measures the cycle of the VFO regions, whereas the frequency error detector 13 measures the cycle of the SYNC patterns.

FIG. 4 shows the configuration of the frequency error detector 13. The frequency error detector 13 primarily comprises a synchronous pattern detector 25, a cycle measuring unit 26, and a cycle comparing unit 27.

FIG. 5 shows a detailed example of the synchronous pattern detector 25 of FIG. 4. The synchronous pattern detector 25 is constituted by a correlation computing unit 200 and a comparison computing unit 201. In the head of each frame, special data called a SYNC pattern (SYNC) is recorded as shown in FIG. 2A. In all the SYNC patterns, continuous 13-bit ‘1’ or ‘0” and reversed 3-bit data following it are recorded.

The correlation computing unit 200 includes a shift resister 210 which is composed of flipflops 211 to 225 and a calculating unit 226. The bit umber of each flipflop is same as the bit number of the output signal of the high-order interpolation filter 7, and the clock CKS generated by the oscillator 15 is used for the clock. During the SYNC pattern is reproduced, a value obtained by latching and shifting an amplitude value of the SYNC pattern reproduction signal at intervals of 1 clock is stored in the flipflops 211 to 225. The correlation computing unit 200 carries out correlation computation for detecting the SYNC pattern of FIG. 2A. More specifically, assuming that an input signal at time k is Y(k), the correlation computing unit 200 performs the following computation:

$$Y ( k - 15 ) + Y ( k - 14 ) + Y ( k - 13 ) + Y ( k - 12 ) + Y ( k - 11 ) + Y ( k - 10 ) + Y ( k - 9 ) + Y ( k - 8 ) + Y ( k - 7 ) + Y ( k - 6 ) + Y ( k - 5 ) + Y ( k - 4 ) + Y ( k - 3 ) - Y ( k - 2 ) - Y ( k - 1 ) - Y ( k ) .$$

This computing equation may be another equation as long as it is a computation highly correlated to the SYNC pattern. The obtained result is compared with predetermined threshold values (Th, −Th) by the comparison computing unit 201, and in the case where it is greater than Th or smaller than −Th, a SYNC detection pulse shown in FIG. 2C is generated.

The cycle measuring unit 26 and cycle comparing unit 27 of FIG. 4 have functions equivalent to those of the cycle measuring unit 23 and cycle comparing unit 24 in FIG. 3, respectively. The detection cycle of the frequency error detector 13 is 1116 bits, which is shorter than that of the frequency error detector 16 in order to measure the cycle of the SYNC pattern. Consequently, in frequency control using the frequency error detector 13, the control band can be increased from that of the frequency error detector 16. In other words, the oscillation frequency of the oscillator 15 can be adjusted every 1116 bits, enabling high-accuracy frequency control that follows rotational fluctuation of the optical disk.

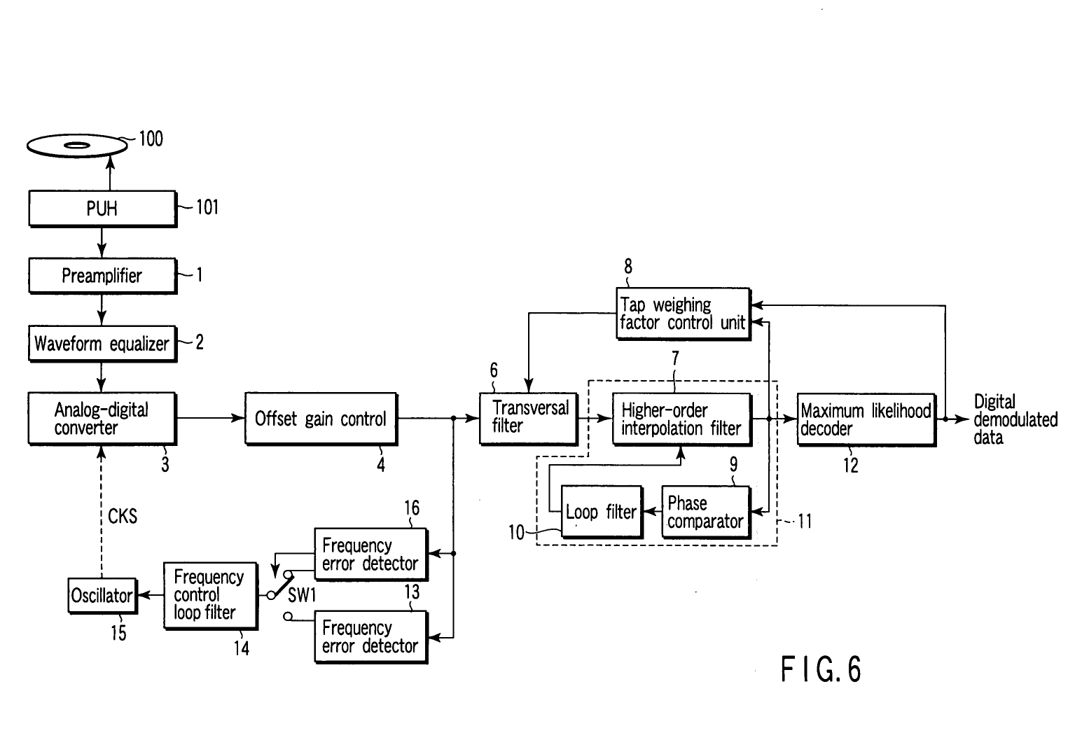

Next, a second embodiment of the present invention will be described. In the data reproduction circuit of the configuration of FIG. 1, an frequency error is detected by the use of a signal after the waveform is equalized by the transversal filter 6 and phase synchronization is carried out by the high-order interpolation filter 7. In order for adaptive control that controls transmission characteristics of the transversal filter 6 to normally function, phase synchronization must be achieved. Consequently, in a state where there is a frequency error (where the phase is not synchronized), there is no guarantee that the transmission characteristics of the transversal filter 6 are the expected characteristics. It is the configuration of FIG. 6 that has solved this kind of problem. The configuration of FIG. 1 and the configuration of FIG. 6 are substantially the same, and constitutional elements of like reference numerals provide the same functions.

The second embodiment is different from the first embodiment in that the output signal of the offset gain control unit 4 is used for an input signal to detect a frequency error in the second embodiment of FIG. 6. With such a configuration, it becomes possible to detect a frequency error without being affected by the transmission characteristics of the transversal filter 6. However, the frequency of the output data of the offset gain control unit 4 coincides with the frequency of the clock CKS generated by the oscillator 15, and in general, it must be set to be slightly higher than the frequency of the reproduction signal from the disk. For example, in order to set a frequency 5% higher than the frequency of the reproduction signal from the disk as the frequency of the oscillator 15, the detection cycle of the VFO region in the frequency error detector 16 must be set about 5% longer than normal 929628 channel bits, and the SYNC pattern detection cycle in the frequency error detector 13 must be set to be about 5% longer than normal 1116 channel bits. Furthermore, in order to carry out correlation computation for a signal which has not yet been waveform-equalized, false detection occurs more frequently as compared with the configuration of FIG. 1. As a consequence, cycle protection conditions in the cycle measuring unit must be more tightened. In this way, it becomes possible to detect a frequency error even when transmission characteristics to be set for the transversal filter 6 are unknown.

As described above, by carrying out frequency error detection and control according to the present invention, it becomes possible to carry out high-accuracy frequency error detection and control even in high-density recorded optical disks such as HD DVD.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk device which decodes data recorded on an optical disk, comprising:
an optical pickup which provides a reproduction signal by irradiating an optical disk with laser beam and detecting reflected light from the optical disk;
an analog-digital converter which digitizes the reproduction signal provided from the optical pickup;
a first measuring unit which measures a cycle of a plurality of first synchronous signal regions contained in the reproduction signal digitized by the analog-digital converter;
a first comparing unit which compares the measurement result of the first measuring unit with a first predetermined cycle;
a second measuring unit which measures a cycle of a plurality of second synchronous signal regions which are contained in the reproduction signal digitized by the analog-digital converter and have the cycle shorter than the cycle of said plurality of first synchronous signal regions;
a second comparing unit which compares the measurement result of the second measuring unit with a second predetermined cycle; and
a generating unit which generates a clock signal for sampling the reproduction signal and provides the clock signal to the analog-digital converter on the basis of the comparison results of the first and second comparing units.

2. The optical disk device according to claim 1, wherein the first comparing unit comprises a determining unit which determines whether or not the measurement result of the fist measuring unit is a cycle between a first threshold value and a second threshold value; and
the optical disk device further comprises a selector unit which selects the comparison result of the first comparing unit when the measurement result of the first measuring unit is a cycle other than the cycle between the first threshold value and the second threshold value, selects the comparison result of the second comparing unit when the measurement result of the first measuring unit is the cycle between the first threshold value and the second threshold value, and provides the selected comparison result to the generating unit.

3. The optical disk device according to claim 1, wherein the second measuring unit comprises a detection unit which detects said plurality of second synchronous signal regions and a unit which measures a cycle of a second synchronous signal region detected by the detection unit, and
the detection unit which detects said plurality of second synchronous signal regions comprises: a shift register which latches and shifts an amplitude value obtained in the reproduction signal of the optical disk at clock intervals generated by the generating unit; a correlation computing unit which computes a correlation by using each flip-flop value that constitutes the relevant shift register; and a comparison computing unit which compares the computing result of the correlation computing unit with a predetermined threshold value, and determines whether or not the signal under reproduction is a signal of the second synchronous signal region.
